(19) United States
(12) Patent Application Publication
(10) Pub. No.: US 2024/0314052 A1
(43) Pub. Date: Sep. 19, 2024

(54) METHOD AND APPARATUS FOR DETERMINING PATH TRANSMISSION DELAY, COMMUNICATION DEVICE, AND STORAGE MEDIUM

(71) Applicant: BEIJING XIAOMI MOBILE SOFTWARE CO., LTD., Beijing (CN)

(72) Inventor: Dong CHEN, Beijing (CN)

(73) Assignee: BEIJING XIAOMI MOBILE SOFTWARE CO., LTD., Beijing (CN)

(21) Appl. No.: 18/263,452

(22) PCT Filed: Feb. 1, 2021
(86) PCT No.: PCT/CN2021/074728

§ 371 Date: Jul. 28, 2023

(51) Int. Cl. H04L 43/0864

(52) U.S. Cl. CPC H04L 43/0864

(57) ABSTRACT

Provided in embodiments of the present disclosure is a method for determining a path transmission delay. The method, applicable in a first user equipment, can include determining, on the basis of the RTT of a data pack between a first address and a second address and of the duration of processing by a processing node on the way, a path transmission delay of transmitting the data pack from the first address to the second address.

### CROSS-REFERENCE

The present application is a U.S. National Stage of International Application No. PCT/CN2021/074728, filed on Feb. 1, 2021, the contents of which are incorporated herein by reference in their entireties for all purposes.

### BACKGROUND

### Technical Field

The present disclosure relates to, but is not limited to, the field of wireless communication technologies, and in particular to a method and apparatus for determining a path transmission delay, a communication device and a storage medium.

### Description of the Related Art

The Internet Protocol (IP) is a communication protocol for transmitting data packets between networks. Based on the IP protocol, IP data packets can be transmitted from a source device (for example, a user's computer) to a destination device (for example, a server, or another computer). The IP protocol realizes the transmission of the data packets based on IP addresses and IP routers. Individual networks are interconnected by the routers. Here, a function of the router may be to select a transmission path for the IP data packet. The IP data packet is transmitted on the selected transmission path.

### SUMMARY

Embodiments of the present disclosure disclose a method and apparatus for determining a path transmission delay, a communication device and a storage medium.

According to a first aspect of embodiments of the present disclosure, there is provided a method for determining a path transmission delay, which is applied to a first user equipment, and the method includes determining, according to a Round-Trip Time (RTT) of a data packet between a first address and a second address and a processing duration of a processing node that the data packet passes through, a path transmission delay of the data packet to be transmitted from the first address to the second address.

According to a second aspect of embodiments of the present disclosure, there is provided a method for determining a path transmission delay, which is applied to a second user equipment, and the method includes receiving information indicating a path transmission delay sent at a first address by a first user equipment. The information indicating the path transmission delay is used by the second user equipment at a second address to determine a transmission delay of transmitting a data packet from the first address to the second address through a processing node.

According to a third aspect of embodiments of the present disclosure, there is provided an apparatus for determining a path transmission delay, which is applied to a first user equipment, and the apparatus includes a determination module. The determination module is configured to determine, according to a RTT of a data packet between a first address and a second address and a processing duration of a processing node that the data packet passes through, a path transmission delay of the data packet to be transmitted from the first address to the second address.

According to a fourth aspect of embodiments of the present disclosure, there is provided an apparatus for determining a path transmission delay, which is applied to a second user equipment, and the apparatus includes a receiving module. The receiving module is configured to receive information indicating a path transmission delay sent at a first address by a first user equipment. The information indicating the path transmission delay is used by the second user equipment at a second address to determine a transmission delay of transmitting a data packet from the first address to the second address through a processing node.

According to a fifth aspect of embodiments of the present disclosure, there is provided a communication device, and the communication device includes a processor and a memory configured to store executable instructions of the processor. The processor is configured to implement the method described in any embodiment of the present disclosure when running the executable instructions.

According to a sixth aspect of embodiments of the present disclosure, there is provided a computer storage medium having a non-transitory computer executable program stored thereon, wherein the executable program, when executed by a processor, implements the method described in any embodiment of the present disclosure.

### BRIEF DESCRIPTION OF THE DRAWINGS

Various exemplary embodiments of this disclosure that are proposed as examples will be described in detail with reference to the following figures, wherein like numerals reference like elements, and wherein:

FIG. 1 is a schematic structural diagram of a wireless communication system.

FIG. 2 is a schematic diagram showing a wireless communication system according to an embodiment of the present disclosure.

FIG. 3 is a schematic flowchart showing a method for determining a path transmission delay according to an embodiment of the present disclosure.

FIG. 4 is a schematic flowchart showing a method for determining a path transmission delay according to an embodiment of the present disclosure.

FIG. 5 is a schematic flowchart showing a method for determining a path transmission delay according to an embodiment of the present disclosure.

FIG. 6 is a schematic flowchart showing a method for determining a path transmission delay according to an embodiment of the present disclosure.

FIG. 7 is a schematic flowchart showing a method for determining a path transmission delay according to an embodiment of the present disclosure.

FIG. 8 is a schematic flowchart showing a method for determining a path transmission delay according to an embodiment of the present disclosure.

FIG. 9 is a schematic flowchart showing a method for determining a path transmission delay according to an embodiment of the present disclosure.

FIG. 10 is a schematic diagram showing an apparatus for determining a path transmission delay according to an embodiment of the present disclosure.

FIG. 11 is a schematic diagram showing an apparatus for determining a path transmission delay according to an embodiment of the present disclosure.

FIG. 12 is a schematic structural diagram showing a terminal according to an embodiment of the present disclosure.

FIG. 13 is a block diagram showing a base station according to an embodiment of the present disclosure.

### DETAILED DESCRIPTION OF THE PREFERRED EMBODIMENTS

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of the embodiments do not represent all implementations consistent with the present disclosure. Instead, they are merely examples of apparatuses and methods consistent with some aspects of the embodiments of the present disclosure as recited in the appended claims.

The terms used in the embodiments of the present disclosure are merely for the purpose of describing particular embodiments and are not intended to limit the embodiments of the present disclosure. As used in the embodiments of the present disclosure and the appended claims, the singular forms “a” and “said” are intended to include the plural forms as well, unless the context clearly indicates otherwise. It should also be understood that the term “and/or” as used herein refers to and includes any or all possible combinations of one or more of the associated listed items.

It should be understood that, although the terms first, second, third, etc. may be used in embodiments of the present disclosure to describe various information, such information should not be limited to these terms. These terms are only used to distinguish the same type of information from each other. For example, without departing from the scope of embodiments of the present disclosure, first information may also be referred to as second information, and similarly, the second information may also be referred to as the first information. Depending on the context, the word “if” as used herein can be interpreted as “upon” or “when” or “in response to determination”.

For the purpose of conciseness and easy understanding, the term used herein when characterizing a size relationship is “greater than” or “less than”. However, those skilled in the art can understand that the term “greater than” also encompasses the meaning of “greater than or equal to”, and the term “less than” also encompasses the meaning of “less than or equal to”.

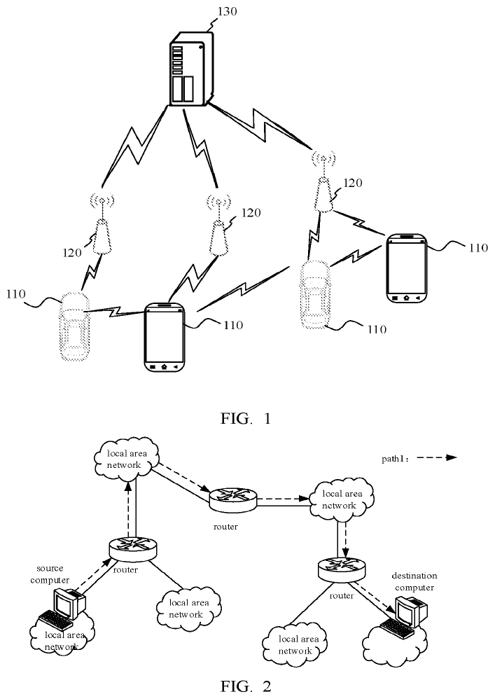

Reference is made to FIG. 1, which shows a schematic structural diagram of a wireless communication system provided by an embodiment of the present disclosure. As illustrated in FIG. 1, the wireless communication system is a communication system based on mobile communication technologies. The wireless communication system may include several user equipments 110 and several base stations 120.

The user equipment 110 may refer to a device that provides voice and/or data connectivity to a user. The user equipment 110 may communicate with one or more core networks via a Radio Access Network (RAN). The user equipment 110 may be an Internet of Things user equipment, such as a sensor device, a mobile phone and a computer with the Internet of Things user equipment, for example, may be a fixed, portable, pocket-sized, handheld, built-in computer or vehicle-mounted device. For example, the user equipment may be a station (STA), a subscriber unit, a subscriber station, a mobile station, a mobile, a remote station, an access point, a remote terminal, an access terminal, a user terminal, a user agent, a user device, or a user equipment. Or, the user equipment 110 may also be a device of an unmanned aerial vehicle. Or, the user equipment 110 may also be a vehicle-mounted device, such as a trip computer with a wireless communication function, or a wireless user equipment connected to an external trip computer. Or, the user equipment 110 may also be a roadside device, such as a streetlight, a signal light or another roadside device with a wireless communication function.

The base station 120 can be a network-side device in a wireless communication system. The wireless communication system can be a 4th generation mobile communication (4G) system, also known as a Long Term Evolution (LTE) system. Or, the wireless communication system may also be a 5G system, also known as a new radio system or a 5G NR system. Or, the wireless communication system may also be a next-generation system of 5G system. An access network in the 5G system can be referred to as a New Generation-Radio Access Network (NG-RAN).

The base station 120 can be an evolved NodeB (eNB) in the 4G system. Or, the base station 120 may also be a gNB with a central distributed architecture in the 5G system. When the base station 120 adopts the central distributed architecture, it usually includes a Central Unit (CU) and at least two Distributed Units (DUs). The CU is provided with a protocol stack of a Packet Data Convergence Protocol (PDCP) layer, a Radio Link Control (RLC) layer, and a Media Access Control (MAC) layer. The DU is provided with a protocol stack of a Physical (PHY) layer. A specific implementation of the base station 120 is not limited in embodiments of the present disclosure.

A wireless connection can be established between the base station 120 and the user equipment 110 through a radio air interface. In different implementations, the radio air interface is a radio air interface based on a 4th generation mobile communication network technology (4G) standard. Or, the radio air interface is a radio air interface based on a 5th generation mobile communication network technology (5G) standard, such as the NR. Or, the radio air interface may also be a radio air interface based on a 5G next-generation mobile communication network technology standard.

In some embodiments, an End to End (E2E) connection may also be established between the user equipments 110, such as a vehicle to vehicle (V2V) communication, a vehicle to infrastructure (V2I) communication and a vehicle to pedestrian (V2P) communication in a vehicle to everything (V2X) communication, and other scenarios.

Here, the above user equipment may be regarded as a terminal device in the following embodiments.

In some embodiments, the above wireless communication system may further include a network management device 130.

The several base stations 120 are connected to the network management device 130, respectively. The network management device 130 can be a core network device in the wireless communication system. For example, the network management device 130 can be a Mobility Management Entity (MME) in an Evolved Packet Core (EPC) network. Or, the network management device may also be another core network device, such as a Serving Gateway (SGW), a Public Data Network Gateway (PGW), a Policy And Charging Rules Function (PCRF) unit or a Home Subscriber Server (HSS). An implementation form of the network management device 130 is not limited in embodiments of the present disclosure.

In order to facilitate the understanding of those skilled in the art, embodiments of the present disclosure list a plurality of implementations to clearly illustrate the technical solutions of the embodiments of the present disclosure. Note that, those skilled in the art can understand that a plurality of embodiments provided by the embodiments of the present disclosure can be executed alone or in combination with methods of other embodiments in the embodiments of the present disclosure. Alternatively, the plurality of embodiments provided by the embodiments of the present disclosure can be executed together with some other methods in the related art or a combination of the plurality of embodiments provided by the embodiments of the present disclosure can be executed together with some other methods, which is not limited in the embodiments of the present disclosure.

In order to better understand the technical solutions described in any of embodiments of the present disclosure, related applications and related scenarios are described.

In the IP protocol, it is stipulated that all devices on a network must have unique IP addresses, just like an address of a recipient must be indicated on a mail, so that a postman can deliver the mail. Likewise, each IP data packet must contain an IP address of a destination device, so that the data packet can be sent to the destination correctly. In an embodiment, the same device can have a plurality of IP addresses, and all network devices using the IP have at least one unique IP address.

The Internet is a large network formed by connecting many networks. If IP information packets are to be transmitted on the Internet, in addition to ensuring that each device on the network has a unique IP address, there also must be a transmission mechanism between networks in order to transmit the IP information packets to the destination through individual networks. This transmission mechanism is called IP routing.

The individual networks are interconnected by routers. A function of the router is to select a transmission path for an IP data packet. During the IP routing, the router is responsible for selecting the path, and the IP data packet is an object to be transmitted. Referring to FIG. 2, the IP data packet is transmitted from a source computer to a destination computer, and may pass through a path 1 as shown in FIG. 2.

In an embodiment, the IP information packet may include a source address and a destination address. For example, a format of the IP data packet is shown in Table 1 below. The IP data packet includes a source address, a destination address, a version, a IHL, a TOS, a total length, an identification, a flag, a fragment offset, a TTL and a protocol etc. . . .

TABLE 1

| | | | |
|---|---|---|---|
| Version | IHL | TOS | Total length |

| | | |
|---|---|---|
| Identification | Flags | Fragment offset |

| | | |
|---|---|---|
| TTL | Protocol | Header checksum |

Source address
Destination address

| | |
|---|---|
| Options (variable length) | Data |

In an embodiment, a data packet is sent by a sender and then transmitted through the router. The router in the network determines how to forward it, and the sender does not determine a forwarding path. Since a processing time of the data packet at each router cannot be determined, it is difficult to determine a time when the data packet reaches the destination address.

In order to solve this problem, in addition to containing the source address and the destination address, the IP data packet may also added with information of a list (also called a flow table) of routers that the IP data packet passes through and information of a processing time (i.e., a time difference that a time when the data packet is sent minus a time when the data packet is received) that the IP data packet is transmitted to the next router (or the destination address) from the current router.

In an embodiment, the IP data packet at least includes the following fields:
a source address, a destination address, a routing address 1, a processing time of a router 1 forwarding a data packet, a routing address 2, a processing time of a router 2 forwarding a data packet, . . . , a routing address N, a processing time of a router N forwarding a data packet.

In an embodiment, after the data packet is sent from the sender, the data packet is sequentially sent to the next hop according to a routing list in the flow table until it is sent to the destination address. That is, the data packet starts from the source address and is sequentially sent to the routing address 1, the routing address 2, . . . , the routing address N, and finally sent to the destination address. For the routing selection, the sender specifies each router on a path that the IP data packet must pass through, there must be no intermediate routers between adjacent routers, and an order of the routers that the data packet passes through cannot be changed.

In an embodiment, in order to determine how many routing addresses the IP data packet needs to pass through to reach the destination address from the source address, the IP data packet may include field information of how many hops it have passed through, for example, field information that the number of hops is N+1.

Since the processing time of the router sending the data packet and the fixed path are stipulated, a time for the data packet to reach the destination address from the source address can be accurately controlled.

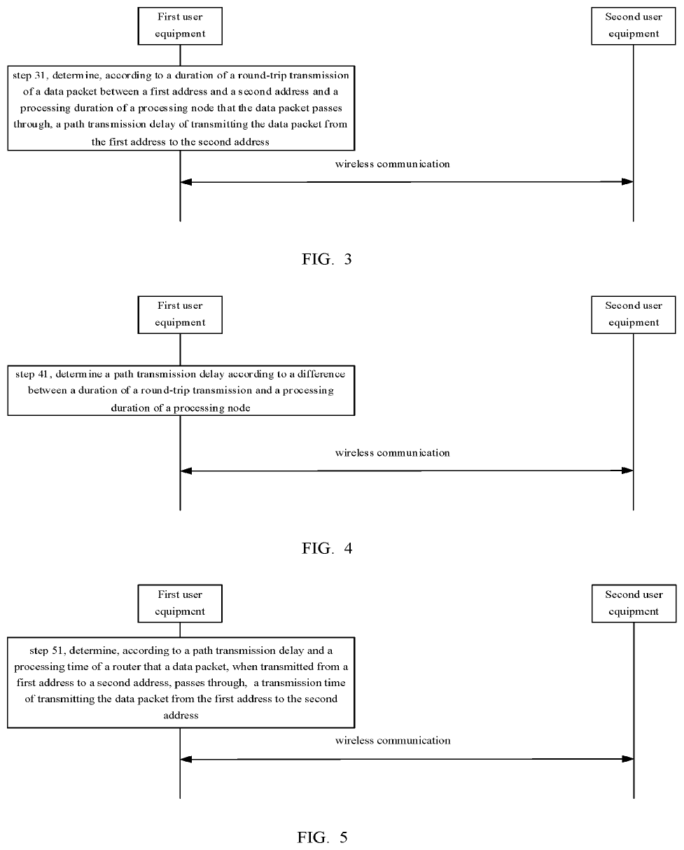

As shown in FIG. 3, an embodiment provides a method for determining a path transmission delay, which is applied to a first user equipment, and the method includes:

in step 31, a path transmission delay of a data packet to be transmitted from a first address to a second address is determined according to a RTT of the data packet between the first address and the second address and a processing duration of a processing node that the data packet passes through.

In an embodiment, the processing duration of the processing node includes a processing duration of a router that the data packet passes through and a processing duration of a second user equipment at the second address forwarding the data packet.

Here, the round-trip transmission may be a round-trip transmission between the first user equipment and the second user equipment, an address of the first user equipment is the first address, and an address of the second user equipment is the second address. That is, after the first user equipment sends the data packet to the second user equipment, the second user equipment forwards the data packet to the first user equipment. In some embodiments, the router can be connected to any device that functions as a gateway. In an embodiment, the network includes a plurality of devices that function as gateways, and each router can connect two or more devices that function as gateways. Here, during the transmission of the data packet, the routers that the data packet passes through include but are not limited to one of the following: a first-hop router, an intermediate-hop router, and a last-hop router. Here, there may be a plurality of intermediate-hop routers. In the Internet, the first-hop router is a router connected to a user equipment at a sending end (for example, a router connected to the source computer in FIG. 2); the intermediate-hop router here is a router that is neither connected to the user equipment at the sending end nor connected to a user equipment at a receiving end; and the last-hop router is a router connected to the user equipment at the receiving end (for example, a router connected to the destination computer in FIG. 2).

In some embodiments, the user equipment may be, but not limited to, a computer, a mobile phone, a wearable device, a vehicle-mounted terminal, a Road Side Unit (RSU), a smart home terminal, an industrial sensor device and/or a medical device, etc. . . . The user equipment can transmit, based on the IP protocol, the data packet to another user equipment through a router on a data transmission path. For example, the first user equipment transmits the data packet to the second user equipment through the router on the data transmission path. Here, each user equipment is configured with an address. For example, the address configured for the first user equipment is the first address, and the address configured for the second user equipment is the second address.

In an embodiment, the path transmission delay of the data packet to be transmitted from the first user equipment to the second user equipment is determined according to the RTT of the data packet between the first user equipment and the second user equipment and the processing duration of the processing node that the data packet passes through. The address of the first user equipment is the first address, and the address of the second user equipment is the second address.

In some embodiments, devices in the network such as the user equipment and the router are configured with address information, and the address information can be used to uniquely identify an address of a device. In an embodiment, the address information includes but is not limited to one of the following: an IP address and a Media Access Control (MAC) address. For example, the address information of the router may be: IP: 10.11.64.1; for another example, the address information of the router may be: MAC: abcd.abcd.0000. Here, the address information of the router can also optionally indicate address information of a position of the network where the router is located. For example, the address information of the router can be: INT4.104, where “INT4” is used to indicate that the router is on a fourth network, and “104” is used to indicate that the router is the 104th router.

In an embodiment, the first user equipment transmits the data packet from the first address to the second address through the data transmission path. Here, the data transmission path includes an address of at least one router through which the data packet reaches the second address from the first address. In an embodiment, the data transmission path includes: the first address, an address of a router 1, an address of a router 2, . . . an address of a router N, and the second address, where N is an integer greater than 1. The address of the first user equipment is the first address, and the address of the second user equipment is the second address. In an embodiment, the address of the router that the data transmission path passes through may also be indicated by the flow table.

In some embodiments, the processing duration of the processing node is used to indicate a duration for the processing node to process the data packet. Here, the processing duration of the processing node includes a processing duration of the router. Here, processing the data packet by the router may be that the router forwards the data packet so as to forward the data packet from the current router to the next-hop router. Here, the processing duration of the router may be determined according to an average processing duration of the router processing the data packet multiple times. Here, the processing duration of the processing node may further include the processing duration of the router and the processing duration of the second user equipment at the second address forwarding the data packet.

In an embodiment, the path transmission delay is used to indicate at least one of the following durations: a duration for the data packet to reach the first-hop router from the first user equipment at the sending end, a duration for the data packet to reach a next-hop router from a previous-hop router, a duration for the data packet to reach the second user equipment at the receiving end from the last-hop router and/or a duration for the second user equipment to forward the data packet. Here, the first user equipment can accurately predict a transmission time for the first user equipment to transmit data to the second user equipment on the data transmission path according to the path transmission delay.

In an embodiment, an address that the data packet passes through during transmission is indicated through the data transmission path.

In an embodiment, if the data transmission path indicates the first address, the address of the router 1 and the second address, the path transmission delay includes a duration for the data packet to reach the router 1 from the first address and a duration for the data packet to reach the second address from the router 1.

In an embodiment, if the data transmission path indicates the first address, the address of the router 1, the address of the router 2 and the second address, the path transmission delay includes the duration for the data packet to reach the router 1 from the first address, a duration for the data packet to reach the router 2 from the router 1, and a duration for the data packet to reach the second address from the router 2.

In an embodiment, the first user equipment sends the data packet to the second user equipment through at least one router on the data transmission path, the address of the first user equipment is the first address, and the address of the second user equipment is the second address. After receiving the data packet, the second user equipment forwards the data packet to the first user equipment through the at least one router on the data transmission path. The first user equipment receives the data packet sent by the second user equipment. The first user equipment determines the RTT of the data packet between the first address and the second address according to a time when the data packet is sent and a time when the data packet is received. The first user equipment determines the path transmission delay of the data packet to be transmitted from the first address to the second address according to the RTT and the processing duration of the processing node that the data packet passes through. Here, the processing node includes the second user equipment and the router.

In an embodiment, the number of round trips is one, and a round-trip duration is a first duration; and the processing node is the router, and the processing duration of the router that the data packet passes through on the data transmission path is a second duration. Then the path transmission delay is ½ of a duration difference between the first duration and the second duration. For example, the round-trip duration is A, and the processing duration of the router that the data packet passes through is B, then the path transmission delay is T, where T=(A−B)/2.

In an embodiment, the number of round trips is N, and the round-trip duration is the first duration; and the processing node is the router, and the processing duration of the router that the data packet passes through on the data transmission path is the second duration. Then the path transmission delay is ½N of the duration difference between the first duration and the second duration. For example, the round-trip duration is A, and the processing duration of the router that the data packet passes through is B, then the path transmission delay is T, where T=(A−B)/2N. Here, N is a positive integer greater than 1. In this way, since the path transmission delay is determined according to the time for multiple round trips, the transmission delay is more accurate.

In an embodiment, the number of round trips is one, and the round-trip duration is the first duration; and the processing node includes the router and the second user equipment, the processing duration of the router that the data packet passes through on the data transmission path is the second duration, and the processing duration of the second user equipment is a third duration. Then the path transmission delay is ½ of a duration difference between the first duration and a sum of the second duration and the third duration. For example, the round-trip duration is A, the processing duration of the router that the data packet passes through is B, and the processing duration of the second user equipment is C, then the path transmission delay is T, where T=(A−B−C)/2.

In an embodiment, the number of round trips is N, and the round-trip duration is the first duration; and the processing node includes the router and the second user equipment, the processing duration of the router that the data packet passes through on the data transmission path is the second duration, and the processing duration of the second user equipment is the third duration. Then the path transmission delay is ½N of the duration difference between the first duration and the sum of the second duration and the third duration. For example, the round-trip duration is A, the processing duration of the router that the data packet passes through is B, and the processing duration of the second user equipment is C, then the path transmission delay is T, where T=(A−B−C)/2N. Here, N is a positive integer greater than 1.

In an embodiment, the processing duration of the processing node includes a duration of processing the data packet by the router that the data packet passes through and a duration of forwarding the data packet by the second user equipment at the second address. For example, the first user equipment sends the data packet to the second user equipment through the router, and after receiving the data packet, the second user equipment forwards the data packet to the first user equipment through the router. Since the second user equipment plays the role of forwarding, the time for the second user equipment to forward the data packet can be included in a total processing time of the processing node.

In an embodiment, the first user equipment determines the data transmission path for the first user equipment to transmit the data to the second user equipment according to a transmission delay required by the data packet transmission and the path transmission delay determined according to any embodiment of the present disclosure. In an embodiment, in response to the delay required by the data packet transmission of the first user equipment being greater than the path transmission delay determined in any embodiment of the present disclosure, it is determined that a path corresponding to the path transmission delay determined in any embodiment of the present disclosure is a data transmission path for the data packet transmission of the first user equipment.

In an embodiment, the first user equipment sends to the second user equipment information indicating the path transmission delay. The second user equipment determines, according to the transmission delay required by the data packet transmission and a transmission delay indicated by the information indicating the transmission delay, a data transmission path for the second user equipment to transmit the data to the first user equipment. In an embodiment, in response to the delay required by the data packet transmission of the second user equipment being greater than the path transmission delay determined in any embodiment of the present disclosure, it is determined that the path corresponding to the transmission delay is a data transmission path for the data packet transmission of the second user equipment.

In an embodiment, in response to the update of the data transmission path for the first user equipment to send the data packet to the second user equipment, the first user equipment determines the path transmission delay of the data packet to be transmitted from the first address to the second address according to the RTT of the data packet between the first address and the second address and the processing duration of the processing node that the data packet passes through. In this way, the first user equipment can accurately determine the transmission delay of transmitting the data packet from the first address to the second address.

In an embodiment, in response to the update of the data transmission path for the first user equipment to send the data packet to the second user equipment, the first user equipment sends to the second user equipment the information indicating the path transmission delay. In this way, the second user equipment can accurately determine the path transmission delay of the data packet to be transmitted from the second user equipment to the first user equipment according to the information indicating the path transmission delay.

In an embodiment, the transmission time of transmitting the data packet between the first user equipment and the second user equipment is a sum of the path transmission delay and the processing time of the router that the data packet passes through. In this way, the first user equipment and/or the second user equipment can accurately determine, based on the path transmission delay and the processing time, the transmission time of transmitting the data packet.

In embodiments of the present disclosure, the path transmission delay of the data packet to be transmitted from the first address to the second address is determined according to the RTT of the data packet between the first address and the second address and the processing duration of the processing node that the data packet passes through. In this way, the first user equipment can accurately determine the path transmission delay of the data packet to be transmitted from the first address to the second address according to the RTT of the data packet and the processing duration of the processing node. During the transmission of subsequent data packets, the time for transmitting the data packets can be accurately determined by using the transmission delay.

It should be noted that those skilled in the art can understand that the method provided by embodiments of the present disclosure may be executed alone, or together with some methods in the embodiments of the present disclosure or some methods in the related art.

As shown in FIG. 4, an embodiment provides a method for determining a path transmission delay, which is applied to a first user equipment, and the method includes:

in step 41, a path transmission delay is determined according to a difference between a RTT and a processing duration of a processing node.

In some embodiments, the RTT may be a duration of a single round-trip transmission of a data packet between a first address and a second address, and the RTT may also be a duration of multiple round-trip transmissions of the data packet between the first address and the second address. An address of the first user equipment is the first address, and an address of the second user equipment is the second address.

In an embodiment, the number of round trips is one, and the determining the path transmission delay according to the difference between the RTT and the processing duration of the processing node includes: the path transmission delay=½(the RTT-two processing times of the router-a processing time of the destination address), and the path transmission delay is determined.

In an embodiment, the number of round trips is N, and the determining the path transmission delay according to the difference between the RTT and the processing duration of the processing node includes: determining the path transmission delay according to ½N of the difference between the RTT and the processing duration of the processing node.

In an embodiment, the number of round trips is one, and a round-trip duration is a first duration; and the processing node is the router, and the processing duration of the router that the data packet passes through on the data transmission path is a second duration. Then the path transmission delay is ½ of a duration difference between the first duration and the second duration. For example, the round-trip duration is A, and the processing duration of the router that the data packet passes through is B, then the path transmission delay is T, where T=(A−B)/2.

In an embodiment, the number of round trips is N, and the round-trip duration is the first duration; and the processing node is the router, and the processing duration of the router that the data packet passes through on the data transmission path is the second duration. Then the path transmission delay is ½N of the duration difference between the first duration and the second duration. For example, the round-trip duration is A, and the processing duration of the router that the data packet passes through is B, then the path transmission delay is T, where T=(A−B)/2N. Here, N is a positive integer greater than 1.

In an embodiment, the number of round trips is one, and the round-trip duration is the first duration; and the processing node includes the router and the second user equipment, the processing duration of the router that the data packet passes through on the data transmission path is the second duration, and the processing duration of the second user equipment is a third duration. Then the path transmission delay is ½ of a duration difference between the first duration and a sum of the second duration and the third duration. For example, the round-trip duration is A, the processing duration of the router that the data packet passes through is B, and the processing duration of the second user equipment is C, then the path transmission delay is T, where T=(A−B−C)/2.

In an embodiment, the number of round trips is N, and the round-trip duration is the first duration; and the processing node includes the router and the second user equipment, the processing duration of the router that the data packet passes through on the data transmission path is the second duration, and the processing duration of the second user equipment is the third duration. Then the path transmission delay is ½N of the duration difference between the first duration and the sum of the second duration and the third duration. For example, the round-trip duration is A, the processing duration of the router that the data packet passes through is B, and the processing duration of the second user equipment is C, then the path transmission delay is T, where T=(A−B−C)/2N. Here, N is a positive integer greater than 1. It should be noted that those skilled in the art can understand that the method provided by embodiments of the present disclosure may be executed alone, or together with some methods in the embodiments of the present disclosure or some methods in the related art.

As shown in FIG. 5, an embodiment provides a method for determining a path transmission delay, which is applied to a first user equipment, and the method includes:

in step 51, a transmission time of transmitting a data packet from a first address to a second address is determined according to a path transmission delay and a processing time of a router that the data packet, when transmitted from the first address to the second address, passes through.

In an embodiment, the transmission time of transmitting the data packet between the first user equipment and the second user equipment is a sum of the transmission delay and the processing time of the router that the data packet, when transmitted from the first address to the second address, passes through. In this way, the first user equipment and/or the second user equipment can accurately determine, based on the path transmission delay and the processing time, the transmission time of transmitting the data packet. The address of the first user equipment is the first address, and the address of the second user equipment is the second address.

In an embodiment, if the data transmission path indicates the first address, the address of the router 1 and the second address, the path transmission delay includes a first duration for the data packet to reach the router 1 from the first address and a second duration for the data packet to reach the second address from the router 1. The processing time of the router that the data packet, when transmitted from the first address to the second address, passes through is the processing time of the router 1, and the processing time of the router 1 is a third duration. It is determined that the transmission time of transmitting the data packet from the first address to the second address is a sum of the first duration, the second duration and the third duration according to the transmission delay and the processing time of the router that the data packet, when transmitted from the first address to the second address, passes through.

In an embodiment, if the data transmission path indicates the first address, the address of the router 1, the address of the router 2 and the second address, the path transmission delay includes the first duration for the data packet to reach the router 1 from the first address, a second duration for the data packet to reach the router 2 from the router 1, and a third duration for the data packet to reach the second address from the router 2. The processing time of the router that the data packet, when transmitted from the first address to the second address, passes through is the processing time of the router 1 and the router 2, where the processing time of the router 1 is a fourth duration, and the processing time of the router 2 is a fifth duration. It is determined that the transmission time of transmitting the data packet from the first address to the second address is a sum of the first duration, the second duration, the third duration, the fourth duration and the fifth duration according to the transmission delay and the processing time of the router that the data packet, when transmitted from the first address to the second address, passes through.

It should be noted that those skilled in the art can understand that the method provided by embodiments of the present disclosure may be executed alone, or together with some methods in the embodiments of the present disclosure or some methods in the related art.

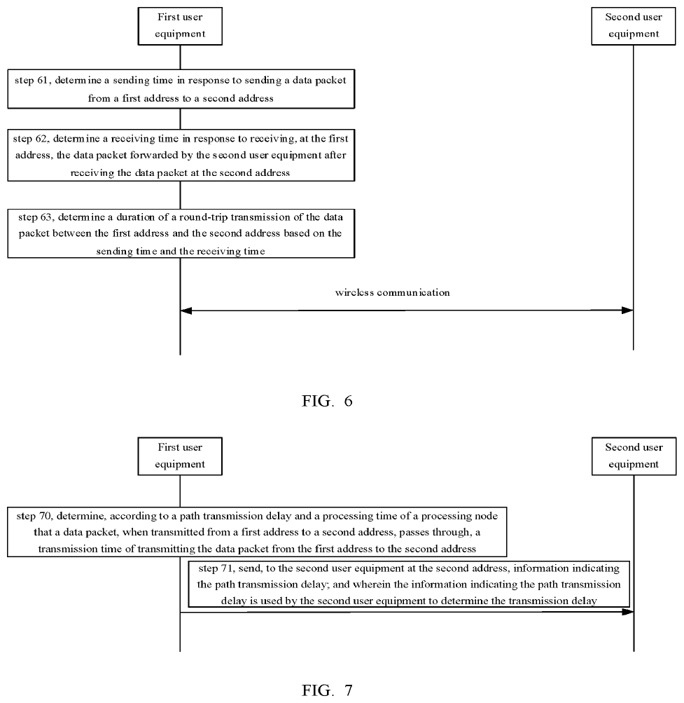

As shown in FIG. 6, an embodiment provides a method for determining a path transmission delay, which is applied to a first user equipment, and the method includes:

in step 61, in response to sending a data packet from a first address to a second address, a sending time is determined, in step 62, in response to receiving, at the first address, the data packet forwarded by a second user equipment after receiving the data packet at the second address, a receiving time is determined, and in step 63, based on the sending time and the receiving time, a RTT of the data packet between the first address and the second address is determined.

Here, the sending time may be a time point when the data packet is sent, and the receiving time may be a time point when the data packet is received.

In an embodiment, in response to the first user equipment sending the data packet from the first address to the second user equipment at the second address, the first user equipment determines a first time when the data packet is sent. In response to the first user equipment receiving, at the first address, the data packet forwarded by the second user equipment after receiving the data packet at the second address, the first user equipment determines a second time when the data packet is received. Based on the first time and the second time, the RTT of the data packet between the first address and the second address is determined. Here, the RTT of the data packet between the first address and the second address may be a difference between the second time and the first time.

In an embodiment, the data packet may be periodically sent and received, and the sending time and receiving time may be obtained multiple times. Based on an average value of multiple sending times and receiving times, the RTT of the data packet between the first address and the second address is determined. In this way, the RTT is more precise.

It should be noted that those skilled in the art can understand that the method provided by embodiments of the present disclosure may be executed alone, or together with some methods in the embodiments of the present disclosure or some methods in the related art.

As shown in FIG. 7, an embodiment provides a method for determining a path transmission delay, which is applied to a first user equipment, and the method includes:

in step 71, information indicating a path transmission delay is sent to a second user equipment at a second address, and the information indicating the path transmission delay is used by the second user equipment to determine a transmission delay.

In an embodiment, in response to the update of the data transmission path for the first user equipment to send the data packet to the second user equipment, the first user equipment determines the path transmission delay of the data packet to be transmitted from the first address to the second address according to the RTT of the data packet between the first address and the second address and the processing duration of the processing node that the data packet passes through.

In an embodiment, in response to the update of the data transmission path for the first user equipment to send the data packet to the second user equipment, the first user equipment sends to the second user equipment the information indicating the path transmission delay.

In an embodiment, the transmission time of transmitting the data packet between the first user equipment and the second user equipment is the sum of the path transmission delay and the processing time of the processing node that the data packet passes through. In this way, the second user equipment can accurately determine, based on the path transmission delay and the processing time, the transmission time of transmitting the data packet.

In an embodiment, the first user equipment sends to the second user equipment the information indicating the path transmission delay. The second user equipment determines, according to the transmission delay required by the data packet transmission and the path transmission delay indicated by the information indicating the path transmission delay, a data transmission path for the second user equipment to transmit the data to the first user equipment. In an embodiment, in response to the delay required by the data packet transmission of the second user equipment being greater than the path transmission delay determined in any embodiment of the present disclosure, it is determined that a path corresponding to the path transmission delay is a data transmission path for the data packet transmission of the second user equipment.

It should be noted that those skilled in the art can understand that the method provided by embodiments of the present disclosure may be executed alone, or together with some methods in the embodiments of the present disclosure or some methods in the related art.

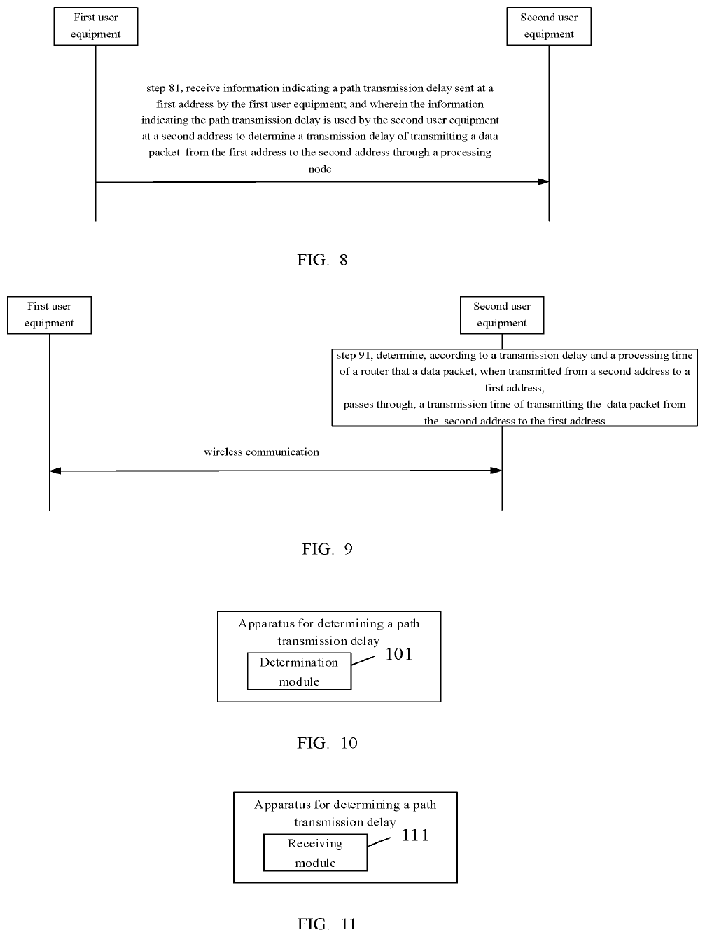

As shown in FIG. 8, an embodiment provides a method for determining a path transmission delay, which is applied to a second user equipment, and the method includes:

in step 81, information indicating a path transmission delay sent by a first user equipment at a first address is received, and the information indicating the path transmission delay is used by the second user equipment at a second address to determine a transmission delay of transmitting a data packet from the first address to the second address through a processing node.

In an embodiment, a processing duration of the processing node includes a processing duration of a router that the data packet passes through.

In some embodiments, the router can be connected to any device that functions as a gateway. In an embodiment, the network includes a plurality of devices that function as gateways, and each router can connect two or more devices that function as gateways. Here, during the transmission of the data packet, the routers that the data packet passes through include but are not limited to one of the following: a first-hop router, an intermediate-hop router, and a last-hop router. Here, there may be a plurality of intermediate-hop routers. In the Internet, the first-hop router is a router connected to a user equipment at a sending end (for example, a router connected to the source computer in FIG. 2); the intermediate-hop router here is a router that is neither connected to the user equipment at the sending end nor connected to a user equipment at a receiving end; and the last-hop router is a router connected to the user equipment at the receiving end (for example, a router connected to the destination computer in FIG. 2).

In some embodiments, the user equipment may be, but not limited to, a computer, a mobile phone, a wearable device, a vehicle-mounted terminal, a RSU, a smart home terminal, an industrial sensor device and/or a medical device, etc. . . . The user equipment can transmit, based on the IP protocol, the data packet to another user equipment through a router on a data transmission path. For example, the first user equipment transmits the data packet to the second user equipment through the router on the data transmission path. Here, each user equipment is configured with an address. For example, the address configured for the first user equipment is the first address, and the address configured for the second user equipment is the second address.

In an embodiment, the first user equipment determines the path transmission delay of the data packet to be transmitted from the first user equipment to the second user equipment according to the RTT of the data packet between the first user equipment and the second user equipment and the processing duration of the processing node that the data packet passes through. The address of the first user equipment is the first address, and the address of the second user equipment is the second address. The following is an illustrative description of the technical solution for determining the path transmission delay by the first user equipment.

In some embodiments, devices in the network such as the user equipment and the router are configured with address information, and the address information can be used to uniquely identify an address of a device. In an embodiment, the address information includes but is not limited to one of the following: an IP address and a MAC address. For example, the address information of the router may be: IP: 10.11.64.1; for another example, the address information of the router may be: MAC: abcd.abcd.0000. Here, the address information of the router can also optionally indicate address information of a position of the network where the router is located. For example, the address information of the router can be: INT4.104, where “INT4” is used to indicate that the router is on a fourth network, and “104” is used to indicate that the router is the 104th router.

In an embodiment, the first user equipment transmits the data packet from the first address to the second address through the data transmission path. Here, the data transmission path includes an address of at least one router through which the data packet reaches the second address from the first address. In an embodiment, the data transmission path includes: the first address, an address of a router 1, an address of a router 2, . . . an address of a router N, and the second address, where N is an integer greater than 1. The address of the first user equipment is the first address, and the address of the second user equipment is the second address. In an embodiment, the address of the router that the data transmission path passes through may also be indicated by the flow table. It should be noted that the second user equipment may also transmit the data packet from the second address to the first address through the data transmission path.

In some embodiments, the processing duration of the processing node is used to indicate a duration for the processing node to process the data packet. Here, the processing duration of the processing node includes a processing duration of the router. Here, processing the data packet by the router may be that the router forwards the data packet so as to forward the data packet from the current router to the next-hop router. Here, the processing duration of the router may be determined according to an average processing duration of the router processing the data packet multiple times. Here, the processing duration of the processing node may further include the processing duration of the router and the processing duration of the second user equipment at the second address forwarding the data packet.

In an embodiment, the path transmission delay is used to indicate at least one of the following durations: a duration for the data packet to reach the first-hop router from the first user equipment at the sending end, a duration for the data packet to reach a next-hop router from a previous-hop router, a duration for the data packet to reach the second user equipment at the receiving end from the last-hop router and/or a duration for the second user equipment to forward the data packet. Here, the first user equipment can accurately predict a transmission time for the first user equipment to transmit data to the second user equipment on the data transmission path according to the path transmission delay.

In an embodiment, an address that the data packet passes through during transmission is indicated through the data transmission path.

In an embodiment, if the data transmission path indicates the first address, the address of the router 1 and the second address, the path transmission delay includes a duration for the data packet to reach the router 1 from the first address and a duration for the data packet to reach the second address from the router 1.

In an embodiment, if the data transmission path indicates the first address, the address of the router 1, the address of the router 2 and the second address, the path transmission delay includes the duration for the data packet to reach the router 1 from the first address, a duration for the data packet to reach the router 2 from the router 1, and a duration for the data packet to reach the second address from the router 2.

In an embodiment, the first user equipment sends the data packet to the second user equipment through at least one router on the data transmission path, the address of the first user equipment is the first address, and the address of the second user equipment is the second address. After receiving the data packet, the second user equipment forwards the data packet to the first user equipment through the at least one router on the data transmission path. The first user equipment receives the data packet sent by the second user equipment. The first user equipment determines the RTT of the data packet between the first address and the second address according to a time when the data packet is sent and a time when the data packet is received. The first user equipment determines the path transmission delay of the data packet to be transmitted from the first address to the second address according to the RTT and the processing duration of the processing node that the data packet passes through. Here, the processing node includes the second user equipment and the router.

In an embodiment, the number of round trips is one, and a round-trip duration is a first duration; and the processing node is the router, and the processing duration of the router that the data packet passes through on the data transmission path is a second duration. Then the path transmission delay is ½ of a duration difference between the first duration and the second duration. For example, the round-trip duration is A, and the processing duration of the router that the data packet passes through is B, then the path transmission delay is T, where T=(A−B)/2.

In an embodiment, the number of round trips is N, and the round-trip duration is the first duration; and the processing node is the router, and the processing duration of the router that the data packet passes through on the data transmission path is the second duration. Then the path transmission delay is ½N of the duration difference between the first duration and the second duration. For example, the round-trip duration is A, and the processing duration of the router that the data packet passes through is B, then the path transmission delay is T, where T=(A−B)/2N. Here, N is a positive integer greater than 1. In this way, since the path transmission delay is determined according to the time for multiple round trips, the transmission delay is more accurate.

In an embodiment, the number of round trips is one, and the round-trip duration is the first duration; and the processing node includes the router and the second user equipment, the processing duration of the router that the data packet passes through on the data transmission path is the second duration, and the processing duration of the second user equipment is a third duration. Then the path transmission delay is ½ of a duration difference between the first duration and a sum of the second duration and the third duration. For example, the round-trip duration is A, the processing duration of the router that the data packet passes through is B, and the processing duration of the second user equipment is C, then the path transmission delay is T, where T=(A−B−C)/2.

In an embodiment, the number of round trips is N, and the round-trip duration is the first duration; and the processing node includes the router and the second user equipment, the processing duration of the router that the data packet passes through on the data transmission path is the second duration, and the processing duration of the second user equipment is the third duration. Then the path transmission delay is ½N of the duration difference between the first duration and the sum of the second duration and the third duration. For example, the round-trip duration is A, the processing duration of the router that the data packet passes through is B, and the processing duration of the second user equipment is C, then the path transmission delay is T, where T=(A−B−C)/2N. Here, N is a positive integer greater than 1.

In an embodiment, the processing duration of the processing node includes a duration of processing the data packet by the router that the data packet passes through and a duration of forwarding the data packet by the second user equipment at the second address. For example, the first user equipment sends the data packet to the second user equipment through the router, and after receiving the data packet, the second user equipment forwards the data packet to the first user equipment through the router. Since the second user equipment plays the role of forwarding, the time for the second user equipment to forward the data packet can be included in a total processing time of the processing node that the data packet passes through.

In an embodiment, the first user equipment determines the data transmission path for the first user equipment to transmit the data to the second user equipment according to a transmission delay required by the data packet transmission and the path transmission delay determined according to any embodiment of the present disclosure. In an embodiment, in response to the delay required by the data packet transmission of the first user equipment being greater than the path transmission delay determined in any embodiment of the present disclosure, it is determined that a path corresponding to the path transmission delay determined in any embodiment of the present disclosure is a data transmission path for the data packet transmission of the first user equipment.

In an embodiment, the first user equipment sends to the second user equipment information indicating the path transmission delay. The second user equipment determines, according to the transmission delay required by the data packet transmission and a transmission delay indicated by the information indicating the transmission delay, a data transmission path for the second user equipment to transmit the data to the first user equipment. In an embodiment, in response to the delay required by the data packet transmission of the second user equipment being greater than the path transmission delay determined in any embodiment of the present disclosure, it is determined that the path corresponding to the transmission delay is a data transmission path for the data packet transmission of the second user equipment.

In an embodiment, in response to the update of the data transmission path for the first user equipment to send the data packet to the second user equipment, the first user equipment determines the path transmission delay of the data packet to be transmitted from the first address to the second address according to the RTT of the data packet between the first address and the second address and the processing duration of the processing node that the data packet passes through.

In an embodiment, in response to the update of the data transmission path for the first user equipment to send the data packet to the second user equipment, the first user equipment sends to the second user equipment the information of the transmission delay.

In an embodiment, the transmission time of transmitting the data packet between the first user equipment and the second user equipment is a sum of the path transmission delay and the processing time of the router that the data packet passes through. In this way, the second user equipment can accurately determine, based on the path transmission delay and the processing time, the transmission time of transmitting the data packet.

It should be noted that those skilled in the art can understand that the method provided by embodiments of the present disclosure may be executed alone, or together with some methods in the embodiments of the present disclosure or some methods in the related art.

As shown in FIG. 9, an embodiment provides a method for determining a path transmission delay, which is applied to a second user equipment, and the method includes:

in step 91, a transmission time of transmitting a data packet from a second address to a first address is determined according to a transmission delay and a processing time of a router that the data packet, when transmitted from the second address to the first address, passes through.

In an embodiment, the transmission time of transmitting the data packet between the first user equipment and the second user equipment is a sum of the path transmission delay and the processing time of the router that the data packet, when transmitted from the second address to the first address, passes through. In this way, the second user equipment can accurately determine, based on the path transmission delay and the processing time, the transmission time of transmitting the data packet. The address of the first user equipment is the first address, and the address of the second user equipment is the second address.

In an embodiment, if the data transmission path indicates the second address, the address of the router 1 and the first address, the path transmission delay includes a first duration for the data packet to reach the router 1 from the second address and a second duration for the data packet to reach the first address from the router 1. The processing time of the router that the data packet, when transmitted from the second address to the first address, passes through is the processing time of the router 1, and the processing time of the router 1 is a third duration. It is determined that the transmission time of transmitting the data packet from the second address to the first address is a sum of the first duration, the second duration and the third duration according to the transmission delay and the processing time of the router that the data packet, when transmitted from the second address to the first address, passes through.

In an embodiment, if the data transmission path indicates the second address, the address of the router 1, the address of the router 2 and the first address, the path transmission delay includes the first duration for the data packet to reach the router 1 from the second address, a second duration for the data packet to reach the router 2 from the router 1, and a third duration for the data packet to reach the first address from the router 2. The processing time of the router that the data packet, when transmitted from the second address to the first address, passes through is the processing time of the router 1 and the router 2, where the processing time of the router 1 is a fourth duration, and the processing time of the router 2 is a fifth duration. It is determined that the transmission time of transmitting the data packet from the second address to the first address is a sum of the first duration, the second duration, the third duration, the fourth duration and the fifth duration according to the transmission delay and the processing time of the router that the data packet, when transmitted from the second address to the first address, passes through.

It should be noted that those skilled in the art can understand that the method provided by embodiments of the present disclosure may be executed alone, or together with some methods in the embodiments of the present disclosure or some methods in the related art.

As shown in FIG. 10, an embodiment of the present disclosure provides an apparatus for determining a path transmission delay, which is applied to a first user equipment, and the apparatus includes a determination module 101.

The determination module 101 is configured to determine, according to a RTT of a data packet between a first address and a second address and a processing duration of a processing node that the data packet passes through, a path transmission delay of the data packet to be transmitted from the first address to the second address.

It should be noted that those skilled in the art can understand that the method provided by embodiments of the present disclosure may be executed alone, or together with some methods in the embodiments of the present disclosure or some methods in the related art.

As shown in FIG. 11, an embodiment of the present disclosure provides an apparatus for determining a path transmission delay, which is applied to a second user equipment, and the apparatus includes a receiving module 111.

The receiving module 111 is configured to receive information indicating a path transmission delay sent at a first address by a first user equipment; and

the information indicating the path transmission delay is used by the second user equipment at a second address to determine a transmission delay of transmitting a data packet from the first address to the second address through a processing node.

Regarding the apparatus in the foregoing embodiments, a specific manner in which each module executes operations has been described in detail in embodiments related to the method, and will not be described in detail here.

Embodiments of the present disclosure provide a communication device, and the communication device includes a processor and a memory configured to store executable instructions of the processor. The processor is configured to implement the method applied to any embodiment of the present disclosure when running the executable instructions.

The memory may include various types of storage mediums, which is a non-transitory computer storage medium that can continue to memorize information stored on it after the communication device is powered off.

The processor may be connected to the memory through a bus or the like, and may be configured to read an executable program stored in the memory.

Embodiments of the present disclosure further provide a computer storage medium having a computer executable program stored thereon, and the executable program, when executed by a processor, implements the method in any embodiment of the present disclosure.

Regarding the apparatus in the foregoing embodiments, a specific manner in which each module executes operations has been described in detail in embodiments related to the method, and will not be described in detail here.

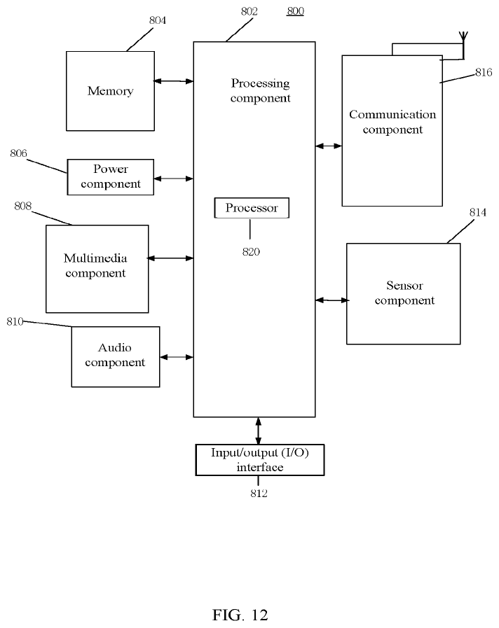

As shown in FIG. 12, an embodiment of the present disclosure provides a structure of a terminal.

Reference is made to a terminal 800 shown in FIG. 12. The embodiment provides the terminal 800, which may specifically be a mobile phone, a computer, a digital broadcast terminal, a messaging apparatus, a gaming console, a tablet, a medical apparatus, exercise equipment, a personal digital assistant, etc.

Referring to FIG. 12, the terminal 800 may include one or more of the following components a processing component 802, a memory 804, a power component 806, a multimedia component 808, an audio component 810, an input/output (I/O) interface 812, a sensor component 814, and a communication component 816.

The processing component 802 typically controls overall operations of the terminal 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the terminal 800. Examples of such data include instructions for any applications or methods operated on the terminal 800, contact data, phonebook data, messages, pictures, video, etc. The memory 804 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the terminal 800. The power component 806 may include a power management system, one or more power sources, and any other components associated with the generation, management, and distribution of power in the terminal 800.

The multimedia component 808 includes a screen providing an output interface between the terminal 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the terminal 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (MIC) configured to receive an external audio signal when the terminal 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the terminal 800. For instance, the sensor component 814 may detect an open/closed status of the terminal 800, relative positioning of components, e.g., the display and the keypad, of the terminal 800, a change in position of the terminal 800 or a component of the terminal 800, a presence or absence of user contact with the terminal 800, an orientation or an acceleration/deceleration of the terminal 800, and a change in temperature of the terminal 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the terminal 800 and other devices. The terminal 800 may access a wireless network based on any communication standard, such as WiFi, 2G, or 3G, or a combination thereof. In an embodiment, the communication component 816 receives a broadcast signal or broadcast associated information from an external broadcast management system via a broadcast channel. In an embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment, the terminal 800 may be implemented with one or more application specific integrated circuits (ASICs), digital signal processors (DSPs), digital signal processing apparatuses (DSPDs), programmable logic apparatuses (PLDs), field programmable gate arrays (FPGAs), controllers, micro-controllers, microprocessors, or other electronic components, for performing the above described methods.

In an embodiment, there is also provided a non-transitory computer readable storage medium including instructions, such as the memory 804 including instructions, the above instructions may be executed by the processor 820 in the terminal 800 for performing the above-described methods. For example, the non-transitory computer-readable storage medium may be a ROM, a Random Access Memory (RAM), a CD-ROM, a magnetic tape, a floppy disc, an optical data storage device, and the like.

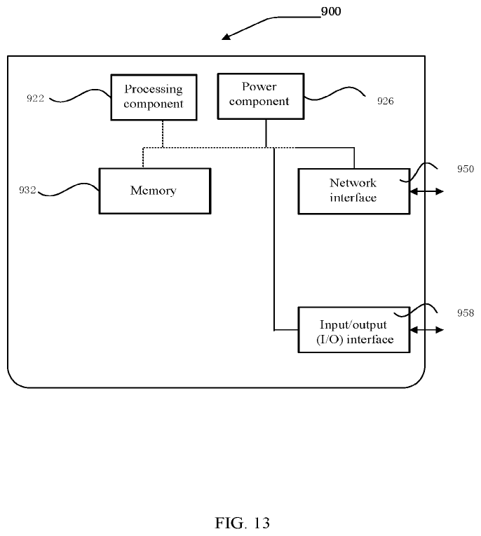

As shown in FIG. 13, an embodiment of the present disclosure shows a structure of a base station. For example, the base station 900 may be provided as a network-side device. Referring to FIG. 13, the base station 900 includes a processing component 922, which further includes one or more processors and a memory resource represented by a memory 932 for storing instructions executable by the processing component 922, such as an application program. The application program stored in the memory 932 may include one or more modules, each corresponding to a set of instructions. In addition, the processing component 922 is configured to execute the instructions to execute any of the aforementioned methods applied in the base station.

The base station 900 may also include: a power component 926 configured to perform power management of the base station 900, a wired or wireless network interface 950 configured to connect the base station 900 to the network, and an input/output (I/O) interface 958. The base station 900 may operate an operating system stored in the memory 932, such as Windows Server™, Mac OS X™, Unix™, Linux™, FreeBSD™, or the like.

Other embodiments of the present disclosure will be apparent to those skilled in the art from consideration of the specification and practice of the present disclosure disclosed here. The present disclosure is intended to cover any variations, uses, or adaptations of the present disclosure following the general principles thereof and including the common general knowledge or habitual technical means in the technical field not disclosed in the present disclosure. The specification and embodiments are considered as exemplary only, and a true scope and spirit of the present disclosure is indicated by the appending claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A method for determining a path transmission delay, performed by a first user equipment, and comprising:
determining, according to a Round-Trip Time (RTT) of a data packet between a first address and a second address and a processing duration of a processing node that the data packet passes through, a path transmission delay of the data packet to be transmitted from the first address to the second address.

2. The method according to claim 1, wherein the processing duration comprises a processing duration of a router that the data packet passes through and a processing duration of forwarding the data packet by a second user equipment at the second address.

3. The method according to claim 2, wherein the determining, according to the RTT of the data packet between the first address and the second address and the processing duration of the processing node that the data packet passes through, the path transmission delay of the data packet to be transmitted from the first address to the second address comprises:
determining the path transmission delay according to a difference between the RTT and the processing duration of the processing node.

4. The method according to claim 3, wherein the determining the path transmission delay according to the difference between the RTT and the processing duration of the processing node comprises:
the path transmission delay=½N (the RTT—the processing duration of the router the processing duration of the second user equipment), where N is a positive integer greater than or equal to 1.

5. The method according to claim 2, wherein the method further comprises:
determining, according to the path transmission delay and a processing time of the router that the data packet, when transmitted from the first address to the second address, passes through, a transmission time of transmitting the data packet from the first address to the second address.

6. The method according to claim 1, wherein the method further comprises:
determining a sending time in response to sending the data packet from the first address to the second address;
determining a receiving time in response to receiving, at the first address, the data packet forwarded by a second user equipment upon receiving the data packet at the second address; and
determining the RTT of the data packet between the first address and the second address based on the sending time and the receiving time.

7. The method according to claim 1, wherein the method further comprises:
sending, to a second user equipment at the second address, information indicating the path transmission delay; and
wherein the information indicating the path transmission delay is used by the second user equipment to determine the path transmission delay.

8. A method for determining a path transmission delay, performed by a second user equipment, and comprising:
receiving information indicating a path transmission delay sent at a first address by a first user equipment; and
wherein the information indicating the path transmission delay is used by the second user equipment at a second address to determine the path transmission delay of a data packet to be transmitted from the first address to the second address through a processing node.

9. The method according to claim 8, wherein the processing node comprises a router.

10. The method according to claim 9, wherein the method further comprises:
determining, according to the path transmission delay and a processing time of the router that the data packet, when transmitted from the second address to the first address, passes through, a transmission time of transmitting the data packet from the second address to the first address.

11-12. (canceled)

13. A first user equipment, comprising:
a memory; and
a processor, coupled to the antenna and the memory, respectively, configured to, by executing computer executable instructions stored on the memory, control transmission and reception of the antenna, and implement:
determining, according to a RTT of a data packet between a first address and a second address and a processing duration of a processing node that the data packet passes through, a path transmission delay of the data packet to be transmitted from the first address to the second address.

14. A non-transitory computer storage medium having computer executable instructions stored thereon, wherein the computer executable instructions, when executed by a processor, implement the method according to claim 1.

15. The first user equipment according to claim 13, wherein the processing duration of the processing node comprises a processing duration of a router that the data packet passes through and a processing duration of forwarding the data packet by a second user equipment at the second address.

16. The first user equipment according to claim 15, wherein the processor is further configured to:
determine the path transmission delay according to a difference between the RTT and the processing duration of the processing node.

17. The first user equipment according to claim 16, wherein the path transmission delay=½N (the RTT—the processing duration of the router—the processing duration of the second user equipment), where N is a positive integer greater than or equal to 1.

18. The first user equipment according to claim 15, wherein the processor is further configured to:
determine, according to the path transmission delay and a processing time of the router that the data packet, when transmitted from the first address to the second address, passes through, a transmission time of transmitting the data packet from the first address to the second address.

19. The first user equipment according to claim 13, wherein the processor is further configured to:
determine a sending time in response to sending the data packet from the first address to the second address;
determine a receiving time in response to receiving, at the first address, the data packet forwarded by a second user equipment upon receiving the data packet at the second address; and
determine the RTT of the data packet between the first address and the second address based on the sending time and the receiving time.

20. The first user equipment according to claim 13, wherein the processor is further configured to:
send, to a second user equipment at the second address, information indicating the path transmission delay; and
wherein the information indicating the path transmission delay is used by the second user equipment to determine the path transmission delay.

21. A second user equipment, comprising:
a memory; and
a processor, coupled to the antenna and the memory, respectively, configured to, by executing computer executable instructions stored on the memory, control transmission and reception of the antenna, and implement the method for determining the path transmission delay according to claim 8.

22. A non-transitory computer storage medium having computer executable instructions stored thereon, wherein the computer executable instructions, when executed by a processor, implement the method according to claim 8.
